(19) United States
(12) Patent Application Publication
(10) Pub. No.: US 2025/0297133 A1
(43) Pub. Date: Sep. 25, 2025

(54) COATING COMPOSITIONS AND METHODS FOR BLOCKING TANNIN MIGRATION

(71) Applicant: SWIMC LLC, Cleveland, OH (US)

(72) Inventor: Cory G. MILLER, Chardon, OH (US)

(21) Appl. No.: 19/069,487

(22) Filed: Mar. 4, 2025

Related U.S. Application Data
(60) Provisional application No. 63/566,950, filed on Mar. 19, 2024.

(51) Int. Cl. C09D 189/00; B05D 5/00; C09D 121/02

(52) U.S. Cl. CPC C09D 189/005; B05D 5/00; C09D 121/02; B05D 2210/00; B05D 2400/00; B05D 2401/20; B05D 2520/05

(57) ABSTRACT

A tannin-blocking coating is provided. The coating includes a binder resin and casein proteins. The tannin-blocking coating mitigates migration of tannins from a substrate on which the tannin-blocking coating is placed.

### CROSS REFERENCE TO RELATED APPLICATIONS

The present application relates to, and claims priority from, U.S. Provisional Application Ser. No. 63/566,950, filed Marh 19, 2024, pending, the contents of which are incorporated by reference herein in their entirety.

### TECHNICAL FIELD

The present invention relates to a tannin-blocking coating and methods of making the same, the tannin-blocking coating comprising a sufficient amount of tannin-blocking components to mitigate migration of tannins from a substrate on which the tannin-blocking coating is placed.

### BACKGROUND OF THE INVENTION

Coatings are applied to substrates to protect the substrate and also to achieve a desired appearance, including color and sheen. A particular coating may be selected based on the substrate's material. For example, wood coatings may be formulated to have a particular viscosity and opacity suitable to cover the varying texture and color of the wood. Wood substrates with a high amount of tannins, such as pine or cedar, can be particularly difficult to coat because the tannins migrate out of the wood and into overlying coatings. These tannins may leech through several layers of coatings over the wood substrate, resulting in a brown-tinted coating. Oil-based coatings, binder resins, and/or additives have been used to mitigate tannin migration, but these systems limit what other additives and/or resins can be used in the formulation, thereby limiting the properties of the overall coating.

### SUMMARY OF THE INVENTION

One object of the present invention is to provide a tannin-blocking coating that comprises a sufficient amount of casein proteins to mitigate migration of tannins from a substrate on which the tannin-blocking coating is placed.

A further object of the present invention is to provide a coatings system for a substrate, the coatings system comprising at least one layer of the tannin-blocking coating, wherein the tannin-blocking coating comprises more tannins than overlying coating layers.

Another object of the invention is to provide methods for applying the tannin-blocking coating to a substrate.

These and other objects of this invention, alone or in combination, have been satisfied by the discovery of a tannin-blocking coating comprising a binder resin and casein proteins, wherein an amount of the casein proteins in the tannin-blocking coating is sufficient to receive migrating tannins from the substrate while drying and to substantially prevent tannins from migrating out of the tannin-blocking coating after drying. The tannin-blocking coating and methods for applying will be further described in the following detailed description and appended claims.

### BRIEF DESCRIPTION OF THE DRAWINGS

The invention may take physical form in certain parts and arrangements of parts, a preferred embodiment of which will be described in detail in the specification and illustrated in the accompanying drawings which form a part hereof, and wherein:

FIG. 1 illustrates an exemplary chemical structure of a casein protein which may be used in the tannin-blocking coating discussed further herein.

FIG. 2 illustrates a cross-sectional view of some embodiments of a coatings system arranged over a substrate and comprising a tannin-blocking coating as will be discussed further herein.

FIGS. 3, 4, 5, 6, and 7 illustrate cross-sectional views of some embodiments of a method of applying a coatings system over a substrate such that tannins from the substrate are substantially contained within a tannin-blocking coating on the substrate.

FIG. 8 illustrates a flow diagram of some embodiments of a method that may correspond to the method illustrated in FIGS. 3-7.

### DETAILED DESCRIPTION OF THE INVENTION

The recitation of a numerical range using endpoints includes all numbers subsumed within that range (e.g., 1 to 5 includes 1, 1.5, 2, 2.75, 3, 3.80, 4, 5, etc.).

To the extent that the terms “including”, “includes”, “having”, “has”, “with”, or variants thereof are used in the present application, such terms are intended to be inclusive in a manner similar to the term “comprising.” The singular forms “a”, “an” and “the” include plural referents unless the context clearly dictates otherwise. Additionally, the terms “a,” “an,” “the,” “at least one,” and “one or more” are used interchangeably. Thus, for example, a coating composition that contains “an” additive means that the coating composition can include “one or more” additives.

Approximating language, as used herein throughout the specification and claims, may be applied to modify a quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Moreover, unless specifically stated otherwise, a use of the terms “first,” “second,” etc., do not denote an order or importance, but rather the terms “first,” “second,” etc., are used to distinguish one element from another.

The term “comprises” and variations thereof do not have a limiting meaning where these terms appear in the description and claims.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur-this distinction is captured by the terms “may” and “may be.”

The term “acrylic” as used herein includes (meth) acrylic acid, (meth) alkyl acrylate, (meth) acrylamide, (meth) acrylonitrile and their modified forms such as (meth) hydroxyalkyl acrylate. Throughout this document, the word fragment “(meth) acryl” refers to both “methacryl” and “acryl”. For example, (meth) acrylic acid refers to both methacrylic acid and acrylic acid, and methyl (meth) acrylate refers to both methyl methacrylate and methyl acrylate.

The term “aliphatic” when used in the context of a carbon-carbon double bond includes both linear (or open chain) aliphatic carbon-carbon double bonds and cycloaliphatic carbon-carbon double bonds but excludes aromatic carbon-carbon double bonds of aromatic rings.

The term “aqueous” composition or dispersion herein means that particles are dispersed in an aqueous medium. An “aqueous medium” herein has a continuous phase of water that makes up at least 50 weight percent of the aqueous medium, wherein the remaining composition of the aqueous medium comprises particles and water-miscible compound(s) such as, for example, alcohols, glycols, glycol ethers, glycol esters, and the like.

The term “(co) polymer” as used herein includes both homopolymers (polymers containing units from a single monomer) and copolymers (polymers containing units from two or more different monomers), unless otherwise specifically stated.

The term “cross-linker” as used herein refers to a molecule capable of forming a covalent linkage between polymers or between two different regions of the same polymer.

The term “on,” when used in the context of a coating applied on a substrate, includes both coatings applied directly or indirectly to the substrate. Thus, for example, a coating applied to a primer layer overlying a substrate constitutes a coating applied on the substrate.

The terms “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the invention.

As used herein, the term “structural units,” also known as polymerized units, of the named monomer refers to the remnant of the monomer after polymerization, or the monomer in polymerized form.

In accordance with an embodiment of the present invention, a tannin-blocking coating is provided. The tannin-blocking coating includes a binder resin and casein proteins. The tannin-blocking coating mitigates migration of tannins from a substrate on which the tannin-blocking coating is placed.

In accordance with another embodiment of the present invention, a coatings system is provided. The coatings system includes a substrate, a first coating layer arranged over the substrate, and a second coating layer arranged over the first coating layer. The first coating layer includes a binder resin and casein proteins. The first coating layer mitigates migration from the substrate to the second coating layer.

In accordance with yet another embodiment of the present invention, a method of coating a substrate is provided. The method includes applying a first coating layer to the substrate and applying a second coating layer to the first coating layer. The first coating layer includes a binder resin and casein proteins. The first coating layer mitigates tannin migration from the substrate to the second coating layer.

Embodiments of the invention disclosed herein relate to a tannin-blocking coating. The tannin-blocking coating comprises a binder resin and casein proteins. When the tannin-blocking coating is applied to a tannin-containing substrate, tannins may migrate into the tannin-blocking coating from the substrate. Then, the casein proteins interact with the tannins such that the molecular weight of the tannins and casein proteins together is high enough to restrict further movement of the tannins. In some embodiments, the casein proteins bind to the tannins to effectively complex with and sequester the tannins via hydrogen bonding, Van der Waals forces, and molecular entanglement. After the tannin-blocking coating dries, a second coating may be applied to the tannin-blocking coating. The tannins in the tannin-blocking coating may remain adhered to and restricted by the casein proteins in the tannin-blocking coating such that substantially no tannins migrate into the second coating. “Substantially no tannins” or “substantially free of tannins” means that if any tannins did migrate into the second coating, the color of the second coating would not be influenced (or visibly altered) by such a small number of tannins migrating therein.

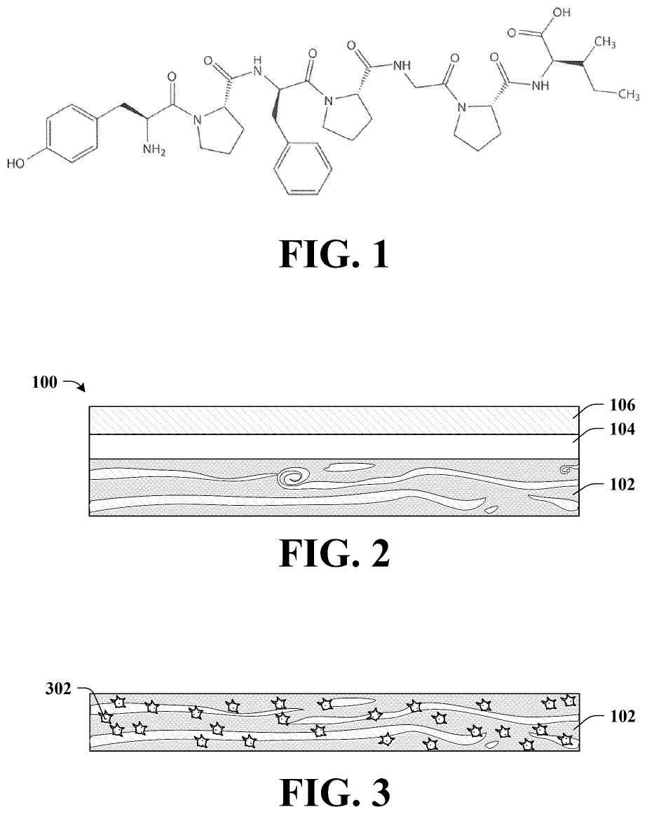

Casein proteins are phosphoproteins with a high proline amino acid content. Several casein protein structures can be found naturally in cow's milk or can be synthetically produced. FIG. 1 illustrates one example of a generic casein protein chemical structure. The tannin-blocking coating described herein may contain casein proteins that all have the same chemical structure or that have varying chemical structures. In cow's milk, casein proteins act as emulsifiers. Thus, in the tannin-blocking coating described herein, the casein proteins may easily mix with a variety of binder resins without causing gelling. Additionally, casein proteins are nonionic, which also increases their compatibility with a variety of binder resins compared to other known tannin-blocking mechanisms.

As long as the pH of the casein proteins when mixed with the binder resin stay above their isoelectric point, the casein proteins will remain nonionic. The binder resin may be anionic, cationic, or nonionic. In some embodiments, the binder resin is preferably acidic to aid in blocking the tannins, which are also an acid. Additionally, as evidenced by its presence in cow's milk, which contains a substantial amount of water, the casein proteins can be used in water-based coating systems. Thus, the binder resin may be waterborne, solventborne, or a mixture thereof (e.g., is aqueous). The tannin-blocking coating may comprise multiple binder resins. The casein proteins may be added to any waterborne or solventborne resin system to provide the tannin-blocking effects. Non-limiting examples of the one or more binder resins in the tannin-blocking coating include acrylic resins (e.g., poly (meth) acrylics), latex resins, polyester resins, polyvinyl ester resins, polyisocyanate resins, alkyd resins, amino resins, epoxy resins, polyurethane resins, polyester resins, silicon-based resins, alkali-soluble resins, and combinations thereof.

In some embodiments, the casein proteins are present in amounts from about 0.1 wt % to about 25 wt %, more preferably about 0.1% to about 20 wt %, even more preferably about 0.5 wt % to about 15 wt %, or even more preferably about 0.5 wt % to about 10 wt % of the total tannin-blocking coating, while remaining parts of the tannin-blocking coating comprises the binder resin and other additives. The amount of casein proteins may also be formulated for a particular substrate. For example, cedar wood has a high amount of tannins. Therefore, a tannin-blocking coating for cedar wood may have a higher amount of casein proteins than a coating formulated for other wood species. The tannin-blocking coating may be applied to natural wood, engineered wood, a wood composite, fiber cement board, a metal, a plastic, a ceramic, or a combination thereof. Thus, while the tannin-blocking coating is formulated in part to block the migration of tannins, the tannin-blocking coating can still be applied to non-tannin-containing substrates.

The amount of casein proteins in the tannin-blocking coating may change the rheology of the overall tannin-blocking coating such as, for example, by increasing the viscosity of the coating mostly in the mid shear and high shear ranges. The amount of casein proteins in the tannin-blocking coating is typically low enough such that such a change in rheology does not limit the application of the tannin-blocking coating (e.g., by rolling, brushing, spraying, etc.). In some embodiments, the tannin-blocking coating may comprise rheology modifiers to offset any undesired rheology changes from the casein proteins and/or to achieve a particular rheology for the application method. For example, in some embodiments, the tannin-blocking coating comprises no more than about 10 wt % of the casein proteins to preserve the application-versatility of the tannin-blocking coating. The desired viscosity of the tannin-blocking coating prior to application to the substrate may be, for example, between 200 and 1500 centipoise at 77 degrees Celsius, as measured in accordance with ASTM D 2196-86. The viscosity measurement may also be performed according to some other suitable viscosity test method.

In some embodiments, the tannin-blocking coating may contain a low amount of casein proteins in view of the amount of tannins in the tannin-containing substrate to which the coating is applied. In some such embodiments, several layers of the tannin-blocking coating may be applied to the tannin-containing substrate, where some tannins may migrate between each tannin-blocking coating. As each tannin-blocking coating layer is applied over the substrate, available casein proteins coagulate with any residual migrating tannins such that together, several layers of the tannin-blocking coating may prevent tannins from migrating into any topcoat layers applied thereon.

In addition to the casein proteins and binder resin(s), the tannin-blocking coating may comprise cationic resins or other additives to enhance the tannin-blocking capabilities of the coating. For example, some embodiments, the tannin-blocking coating may also comprise additional tannin-blocking additives such as polyvinyl polypyrolidones, zinc oxide, or the like. Further, in some embodiments, the tannin-blocking coating functions as a primer layer applied directly over the substrate. Thus, the tannin-blocking coating may comprise additives suitable to aid in the tannin-blocking coating's adhesion to the substrate and/or aid in adhesion between the tannin-blocking coating and an overlying layer formed thereon. Other additives in the tannin-blocking coating may include, for example, pigments, fillers, diluents, extenders, wetting agents, leveling agents, dispersing agents, anti-settling agents, defoamers, rheology modifiers, and the like to achieve desired properties such as viscosity, wetting, cure speed, adhesion, aesthetics, film thickness, and the like. Each optional ingredient is preferably included in a sufficient amount to serve its intended purpose, but not in such an amount to adversely affect the quality of the tannin-blocking coating resulting therefrom, which amounts are generally understood by those of ordinary skill in the art.

Additionally, non-limiting examples of suitable organic solvents for use in the water-based and/or solvent-based coating compositions of the present invention include aliphatic hydrocarbons (e.g., mineral spirits, kerosene, VM&P NAPHTHA solvent, and the like); aromatic hydrocarbons (e.g., benzene, toluene, xylene, the SOLVENT NAPHTHA 100, 150, 200 products and the like); alcohols (e.g., ethanol, n-propanol, isopropanol, n-butanol, iso-butanol and the like); ketones (e.g., acetone, 2-butanone, cyclohexanone, methyl aryl ketones, ethyl aryl ketones, methyl isoamyl ketones, and the like); esters (e.g., ethyl acetate, butyl acetate and the like); glycols (e.g., butyl glycol); glycol ethers (e.g., ethylene glycol monomethyl ether, ethylene glycol monocthyl ether, ethylene glycol monobutyl ether, propylene glycol monomethyl ether, and the like); glycol ether esters (e.g., butyl glycol acetate, methoxypropyl acetate and the like); and mixtures thereof.

It will be appreciated that other embodiments of this invention relate to a tannin-blocking caulk or a tannin-blocking sealant. The tannin-blocking caulk or sealant may comprise casein proteins and a binder resin suitable for caulks or sealants. Compared to the tannin-blocking coating, a tannin-blocking caulk or sealant may have a higher viscosity, have higher thickness, and/or comprise different additives. In some embodiments, a tannin-blocking caulk or sealant may be used in conjunction with a tannin blocking coating to enhance the tannin-blocking effects. For example, two pieces of wood (or some other substrate) may be joined together using a tannin-blocking caulk. The wood substrate and the tannin-blocking caulk may then be coated with the tannin-blocking coating. After one or more layers of the tannin-blocking caulk and/or coating are applied, a topcoat layer may be applied over the wood substrate. Because both the tannin-blocking caulk and the tannin-blocking coating comprise casein proteins, substantially no tannins will migrate into the topcoat layer.

Turning now to FIG. 2, some embodiments of a system 100 comprising various coatings will be described. The system 100 may comprise the tannin-blocking coating 104 arranged over a substrate 102. The tannin-blocking coating 104 may function as a primer layer on the substrate 102. Thus, the tannin-blocking coating 104 may directly contact the substrate 102 or may be spaced apart from the substrate 102 by intervening additional coating layers. In some embodiments, the substrate 102 is a tannin-containing substrate such as wood. The tannin-blocking coating 104 may comprise self-leveling agents to fill any uneven areas on the substrate 102, such as wood grains, while still providing a substantially smooth tannin-blocking coating 104 over the substrate 102. A second coating layer 106 is arranged over the tannin-blocking coating 104. As will be discussed further herein, the tannin-blocking coating 104, which comprises casein proteins, may receive tannins from the substrate 102 but also substantially prevent tannins from migrating further into the second coating layer 106 overlying the tannin-blocking coating 104.

In some embodiments, several layers of the tannin-blocking coating 104 may be arranged over the substrate 102. When dried, each layer of tannin-blocking coating 104 may have a dry film thickness in a range of between, for example, preferably 3 micrometers to 260 micrometers, more preferably 5 micrometers to 30 micrometers, and most preferably 10 micrometers to 20 micrometers. A higher dry film thickness of the tannin-blocking coating 104 may be desired when the substrate 102 contains a higher amount of tannins to increase the number of casein proteins available to coagulate with any mobile tannins migrating out of the substrate 102. In some embodiments, several layers of the tannin-blocking coating 104 may be used to increase the number of casein proteins available to coagulate with any mobile tannins migrating out of the substrate 102. In some embodiments, the aforementioned values of the dry film thickness of each layer of the tannin-blocking coating 104 is the dry film thickness before sanding. In some embodiments, each layer of the tannin-blocking coating 104 is sanded after drying and before application of another coat. In other embodiments, sanding each layer of the tannin-blocking coating 104 is omitted at least because sanding reduces the dry film thickness and in turn, reduces the number of casein proteins available in the tannin-blocking coating 104. Thus, if sanding is performed on each layer of tannin-blocking coating 104, the number of layers of the tannin-blocking coating 104 may be increased to accommodate the loss in dry film thickness from sanding.

FIGS. 3-7 illustrate some embodiments of a method of applying the tannin-blocking coating described herein to a substrate.

As shown in FIG. 3, a substrate 102 is provided. In some embodiments, the substrate 102 may comprise a tannin-containing material or a non-tannin-containing material. As an example, the substrate 102 comprises tannins 302, which are illustrated in FIG. 3 for exemplary purposes. It will be appreciated that while tannins 302 provide a yellow-brown color to a substrate 102 or coating, tannins 302 are not individually discernable to the human eye as illustrated throughout FIGS. 3-7. The tannins 302 may be evenly distributed throughout the substrate 102 or concentrated in certain areas more than others. For example, in some wood-based substrates, tannins 302 are especially concentrated in the wood grains or knots.

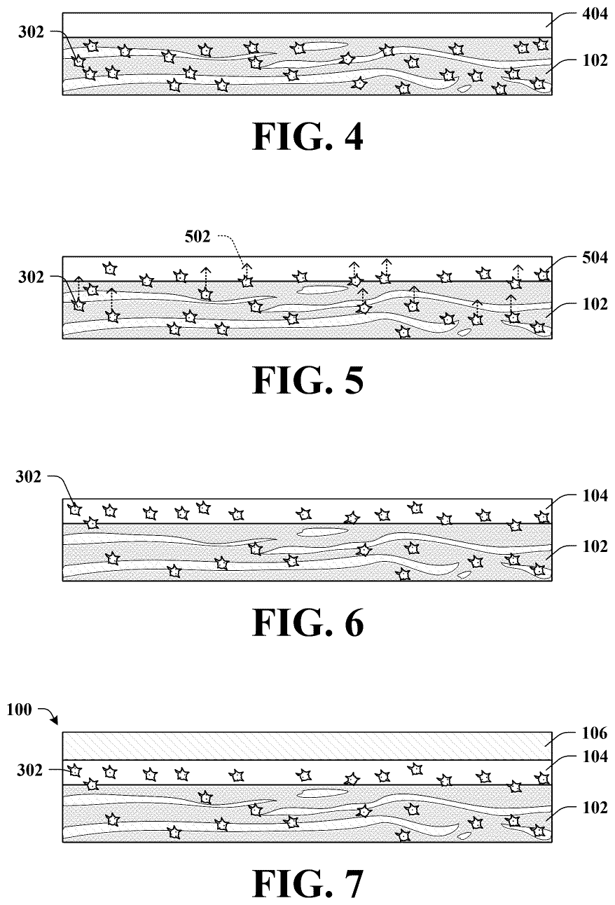

As shown in FIG. 4, a fresh layer 404 of the tannin-blocking coating is applied to the substrate 102. The fresh layer 404 may be applied via brushing, rolling, spraying, or some other suitable application technique. FIG. 4 illustrates the substrate 102 and the fresh layer 404 of the tannin-blocking coating immediately after application of the fresh layer 404.

As shown in FIG. 5, after some time from initial application of the tannin-blocking coating, the tannins 302 begin to migrate 502 out of the substrate 102 and into the partially dried layer 504 of the tannin-blocking coating. As the tannins 302 migrate 502 into the partially dried layer 504, casein proteins that are suspended throughout the partially dried layer 504 adhere to the migrating tannins 302, Over time, the migration 502 of tannins 302 within the partially dried layer 504 slow down and eventually, the tannins 302 become substantially immobile.

As shown in FIG. 6, the tannin-blocking coating 104 dries and entraps tannins 302. The tannin-blocking coating 104 may dry or cure under certain conditions based on the binder resin of the tannin-blocking coating 104. For example, the tannin-blocking coating 104 may dry at room temperature or at an elevated temperature; in the presence of moisture; when exposed to UV light; or under some other drying or curing mechanism suitable for the binder resin(s). Just at application of the tannin-blocking coating 104 (e.g., FIG. 4), the tannin-blocking coating 104 comprises a first amount of tannins 302 (e.g., substantially no tannins); after the application of the tannin-blocking coating 104 but before the tannin-blocking coating 104 dries (e.g., FIG. 5), the tannin-blocking coating 104 comprises a second amount of tannins 302 greater than the first amount of tannins 302; and once the tannin-blocking coating 104 dries (e.g., FIG. 6), the tannin-blocking coating 104 comprises a third amount of tannins 302 greater than the second amount of tannins 302. Similarly, the amount of tannins 302 in the substrate 102 may decrease over time upon the application of the tannin-blocking coating 104 as the tannins 302 migrate 502 out of the substrate 102 and into the tannin-blocking coating 104. Upon drying, the tannins 302 may be trapped within the tannin-blocking coating 104 because the coagulated casein proteins and tannins 302 become too large to migrate through the tannin-blocking coating 104. While the individual tannins 302 are not discernable, the dried tannin-blocking coating 104 may exhibit a yellow-brown tint that was not present prior to coating the substrate 102.

As shown in FIG. 7, a second coating layer 106 is formed over the tannin-blocking coating 104. The casein proteins in the tannin-blocking coating 104 substantially prevent the migration of tannins 302 out of the tannin-blocking coating 104 and into the second coating layer 106. Therefore, the pigment of the second coating layer 106 is not influenced or substantially not influenced by the tannins 302 from the underlying substrate 102 because of the intervening tannin-blocking coating 104. As such, the second coating layer 106 is substantially free of tannins. It will be appreciated that several other layers comprising the same or different compositions as the tannin-blocking coating 104 and the second coating layer 106 may be formed over the substrate 102 to achieve the desired properties of the overall coatings system 100.

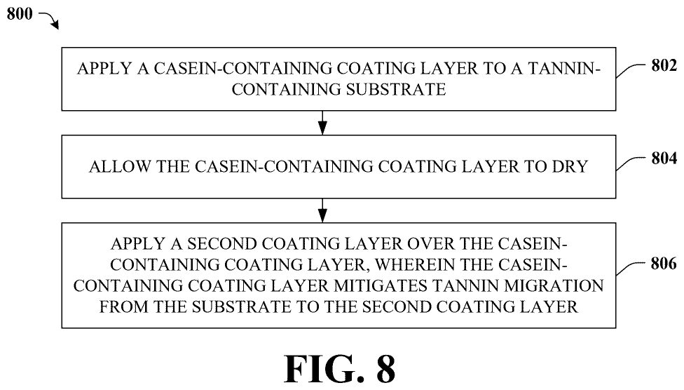

FIG. 8 illustrates a flow diagram 800 of some embodiments of a method of applying a tannin-blocking coating comprising casein proteins to a tannin-containing substrate. In some embodiments, the steps in the flow diagram 800 of FIG. 8 correspond to the method illustrated in FIGS. 3-7.

At step 802, a casein-containing coating layer is applied to a tannin-containing substrate.

At step 804, the casein containing coating layer is dried.

At step 806, a second coating layer is applied over the casein-containing coating layer, wherein the casein-containing coating layer mitigates tannin migration from the substrate to the second coating layer.

The following examples are provided to illustrate the present invention and its advantages but should not be construed as limiting a scope of the invention.

As discussed above, the tannin-blocking coating is configured to receive migrating tannins from the substrate. Therefore, the color of the tannin-blocking coating may change between the time of application and the time of drying. When a second coating layer is applied over the tannin-blocking coating, the casein proteins are intended to prevent tannins from migrating into the second coating layer. Thus, when the disclosed tannin-blocking coating is applied to a tannin-containing substrate before the second coating layer, the change in color of the second coating layer over time should be less than if the tannin-blocking coating were not used. Even if tannins did not migrate into the second coating layer, some color change in the second coating layer may still naturally over time due to other known causes such as moisture, light, and other environmental factors.

The change in color of a coating can be measured using a spectrophotometer, which measures the absorption and intensity of light when directed at a substrate. In the coatings industry, data collected from the spectrophotometer can be collected over time to illustrate the change in color of a coating on a substrate. The spectrophotometer may measure the lightness of a coating based on the amount of white light that is reflected from the coating; the amount of red-green in the coating; the amount of yellow-blue in the coating; and the amount of all colors in the coating. When measuring the change in a coating's color over time, spectrophotometer data may be collected at a first time and at a second time. The data at the first time is compared with the data at the second time and typically reported as a change in lightness (ΔL) and change in hue and chroma (ΔC). The color data change between the first and second times can also be expressed as change in red-green color (ΔC (RG)) and change in yellow-blue color (ΔC (YB)). An overall total color difference (ΔE) may be calculated based on the ΔL, ΔC (RG), ΔC (YB), and ΔC values, as discussed in ASTM D2244.

As an example, Table I presents the change in color of a second coating layer applied over a tannin-containing substrate and shows that the tannin-blocking coatings do mitigate a change in color of coatings formed thereon. Control A does not have any tannin-blocking layer between the second coating layer and the tannin-containing substrate. Samples 1 and 2 include the disclosed casein-containing tannin-blocking coating between the second coating layer and the tannin-containing substrate. The casein-containing tannin-blocking coating in Samples 1 and 2 comprises casein proteins in a latex-based binder resin. Sample 2 comprises a higher % weight of the casein proteins than Sample 1. Control B contains a commercially available tannin-blocking coating between the tannin-containing substrate and the second coating layer. The commercially available tannin-blocking coating is latex-based and comprises known tannin-blocking additives and/or resins but does not contain any casein proteins. Sample 3 includes the disclosed casein-containing tannin-blocking coating between the second coating layer and the tannin-containing substrate. The casein-containing tannin-blocking coating in Sample 3 comprises casein protein added to the commercially available tannin-blocking coating.

TABLE 1*

| Spectrophotometer | Control | Sample | Sample | Control | Sample |
|---|---|---|---|---|---|
| Measurement | A | 1 | 2 | B | 3 |
| ΔL | 100% | 96% | 93% | 47% | 47% |
| ΔC (RG) | 100% | 77% | 84% | 64% | 49% |
| ΔC (YB) | 100% | 81% | 80% | 61% | 43% |
| ΔE | 100% | 85% | 88% | 55% | 47% |
| ΔC | 100% | 79% | 82% | 63% | 46% |

*Results in Table 1 are normalized based on Control A color results, where Control A does not contain any tannin-blocking layers. Thus, 100% indicates the most amount of color change over time.

Each sample panel in Table 1 was prepared and tested according to a same testing procedure. It will be appreciated that the following testing procedure is simply an example, and other time, temperature, and environmental conditions may be used. To gather the data in Table 1, the appropriate tannin-blocking coatings were first brushed onto a redwood substrate for Samples 1, 2, 3 and Control B. The redwood substrate of Control A was left untreated. Each sample panel was then allowed to airdry at ambient temperature for 7 days. Then, each sample panel was coated with a commercially available satin paint as the second coating layer. The samples were again allowed to airdry at ambient temperature for 7 days. After these 7 days of allowing the second coating layer to dry, each sample panel was measured under the spectrophotometer to collect initial color measurements. In some embodiments, the spectrophotometer may collect data at different angles of incidence, such as at gloss (60) and gloss (85). After collecting the initial readings of each sample panel, the sample panels were placed in a humidity chamber set to about 95° F. and about 80% to about 90% relative humidity for 14 days. Such high temperature and humidity conditions were used to allow any mobile tannins to migrate into the second coating layer. After the 14 days in the humidity chamber, each sample panel was allowed to airdry at ambient temperature for 7 days. Then, each sample panel was again measured under the spectrophotometer to collect final color measurements. The final color measurements were compared to the initial color measurements to calculate ΔL, ΔC (RG), ΔC (YB), ΔE, and ΔC values.

Because of the absence of any tannin-blocking layer, Control A had highest ΔL, ΔC (RG), ΔC (YB), ΔE, and ΔC values, which indicates Control A had the most change in color. Therefore, in Table 1, each spectrophotometer measured in Control A was normalized to equal 100% such that “100%” indicates the greatest change in color. The spectrophotometer measurements of each of Samples 1, 2, 3 and Control B were divided by each spectrophotometer measurement of Control A and represented as a percentage. For example, Sample 1 had a 4% decrease in ΔL compared to the ΔL of Control A. Table 1 shows that Samples 1 and 2, which included a tannin-blocking layer comprising casein proteins in a latex-based binder resin, does reduce the amount of color change in the second coating layer. The slight variation in color change values between Sample 1 and 2 shows that in some embodiments, increasing the amount of casein proteins in the tannin-blocking coating does not significantly impact the color changing effects of the tannin-blocking coating. In some embodiments, the tannin-blocking and color changing properties of the tannin-blocking coating do not change significantly when the tannin-blocking coating comprises more than 1 wt % or more preferably more than 0.5 wt % of casein proteins. Additionally, when comparing Control B to Sample 3, Table 1 shows that adding casein proteins to a commercially available tannin-blocking coating further reduces color change in the second coating layer.

In some embodiments, Samples 1, 2, and 3 had ΔE values less than 10, more preferably less than 6.5, and even more preferably less than 3.5. Further, in some embodiments, Samples 1, 2, and 3 had ΔC (RG) values less than 3.5 and more preferably less than 3. In some embodiments, Samples 1, 2, and 3 had ΔC (YB) values less than 3, more preferably less than 2.5, and even more preferably less than 1.5. In some embodiments, Samples 1, 2, and 3 had ΔC values less than 4.5, more preferably less than 4, and even more preferably less than 2.5. In some embodiments, Samples 1, 2, and 3 had ΔL values less in a range of between about −4.9 and about −2. Each of these spectrophotometer values illustrate that the casein-containing tannin-blocking coating mitigates color change in an overlying coating layer.

The following are non-limiting examples of some embodiments of the present invention:

Embodiment 1. A tannin-blocking coating comprising:
a binder resin; and
casein proteins,
wherein the tannin-blocking coating mitigates migration of tannins from a substrate on which the tannin-blocking coating is placed.

Embodiment 2. The tannin-blocking coating of Embodiment 1, wherein an amount of the casein proteins in the tannin-blocking coating is sufficient to receive migrating tannins from the substrate while drying and to substantially prevent tannins from migrating out of the tannin-blocking coating after drying.

Embodiment 3. The tannin-blocking coating of one of Embodiment 1 or Embodiment 2, wherein the casein proteins are present in the tannin-blocking coating in an amount of from about 0.5% to about 10% based on total amount of tannin-blocking coating.

Embodiment 4. The tannin-blocking coating of any one of Embodiments 1 to 3, wherein the binder resin is waterborne.

Embodiment 5. The tannin-blocking coating of any one of Embodiments 1 to 4, wherein the binder resin is a resin having silicon-based groups contained therein.

Embodiment 6. The tannin-blocking coating of any one of Embodiments 1 to 5, wherein the binder resin includes an alkali-soluble resin.

Embodiment 7. The tannin-blocking coating of any one of Embodiments 1 to 6, wherein the binder resin is acidic.

Embodiment 8. The tannin-blocking coating of any one of Embodiments 1 to 7, wherein the binder resin is cationic.

Embodiment 9. The tannin-blocking coating of any one of Embodiments 1 to 8, wherein the binder resin is a member selected from the group consisting of poly (meth) acrylics, epoxies, polyesters, polyvinyl esters, alkyds, polyurethanes, polyisocyanates, amino resins, latexes, and silicon-based resins.

Embodiment 10. A coatings system comprising:
a substrate;
a first coating layer arranged over the substrate; and
a second coating layer arranged over the first coating layer,
wherein the first coating layer comprises:
   a binder resin; and
   casein proteins, and
wherein the first coating layer mitigates tannin migration from the substrate to the second coating layer.

Embodiment 11. The coatings system of Embodiment 10, wherein the substrate comprises tannins, wherein the first coating layer further comprises tannins, and wherein the second coating layer is substantially free of tannins.

Embodiment 12. The coatings system of one of Embodiment 10 or Embodiment 11, wherein the substrate comprises wood, a wood composite, an engineered wood, or a combination thereof.

Embodiment 13. The coatings system of one of Embodiment 10 or Embodiment 11, wherein the substrate comprises metal, plastic, ceramic, or a combination thereof.

Embodiment 14. The coatings system of any one of Embodiments 10 to 13, wherein the first coating layer is waterborne.

Embodiment 15. The coatings system of any one of Embodiments 10 to 14, wherein the binder resin comprises an alkali-soluble resin.

Embodiment 16. The coatings system of any one of Embodiments 10 to 15, wherein the binder resin is a resin having silicon-based groups contained therein.

Embodiment 17. The coatings system of any one of Embodiments 10 to 15, wherein the binder resin is cationic.

Embodiment 18. The coatings system of any one of Embodiments 10 to 17, wherein the binder resin is a member selected from the group consisting of poly (meth) acrylics, epoxies, polyesters, polyvinyl esters, alkyds, polyurethanes, polyisocyanates, amino resins, latexes, and silicon-based resins.

Embodiment 19. A method of coating a substrate comprising:
applying a first coating layer to the substrate; and
applying a second coating layer to the first coating layer,
wherein the first coating layer comprises:
   a binder resin; and
   casein proteins, and
wherein the first coating layer mitigates tannin migration from the substrate to the second coating layer.

Embodiment 20. The method of Embodiment 19, wherein the substrate comprises wood, a wood composite, an engineered wood, or a combination thereof.

Embodiment 21. The method of Embodiment 19, wherein the substrate comprises metal, plastic, ceramic, or a combination thereof.

Embodiment 22. The method of any one of Embodiments 19 to 21, wherein the first coating layer is water-based.

Embodiment 23. The method of any one of Embodiments 19 to 22, wherein before the first coating layer is applied to the substrate, the first coating layer has a first amount of brown color; and wherein after the first coating layer is applied to the substrate, the first coating layer has a second amount of brown color which is greater than the first amount.

All methods described herein can be performed in any suitable order unless otherwise indicated herein or otherwise clearly contradicted by context. The use of any examples, or language describing an example (e.g., “such as”) provided herein, is intended to illuminate the invention and does not pose a limitation on the scope of the invention. Any statement herein as to the nature or benefits of the invention or of the preferred embodiments is not intended to be limiting. This invention includes all modifications and equivalents of the subject matter recited herein as permitted by applicable law. Moreover, any combination of the above-described elements in all possible variations thereof is encompassed by the invention unless otherwise indicated herein or otherwise clearly contradicted by context. The description herein of any reference or patent, even if identified as “prior,” is not intended to constitute a concession that such reference or patent is available as prior art against the present invention. No unclaimed language should be deemed to limit the invention in scope. Any statements or suggestions herein that certain features constitute a component of the claimed invention are not intended to be limiting unless reflected in the appended claims. Neither the marking of the patent number on any product nor the identification of the patent number in connection with any service should be deemed a representation that all embodiments described herein are incorporated into such product or service.

While the embodiments discussed herein have been related to the coatings and methods discussed above, these embodiments are intended to be examples only and are not intended to limit the applicability of these embodiments to only those discussions set forth herein.

The above description is merely illustrative of several possible embodiments of various aspects of the present invention, wherein equivalent alterations and/or modifications will occur to others skilled in the art upon reading and understanding this specification and the annexed drawings. In addition, although a particular feature of the invention may have been disclosed with respect to only one of several implementations, such feature may be combined with one or more other features of the other implementations as may be desired and advantageous for any given or particular application.

Additional modifications and variations of the present invention are possible in light of the above teachings. It is therefore to be understood that within the scope of the appended claims, the invention may be practiced otherwise than as specifically described herein.

What is claimed is:

1. A tannin-blocking coating comprising:
a binder resin; and
casein proteins,
wherein the tannin-blocking coating mitigates migration of tannins from a substrate on which the tannin-blocking coating is placed.

2. The tannin-blocking coating of claim 1, wherein an amount of the casein proteins in the tannin-blocking coating is sufficient to receive migrating tannins from the substrate while drying and to substantially prevent tannins from migrating out of the tannin-blocking coating after drying.

3. The tannin-blocking coating of claim 1, wherein the casein proteins are present in the tannin-blocking coating in an amount of from about 0.5% to about 10% based on total amount of tannin-blocking coating.

4. The tannin-blocking coating of claim 1, wherein the binder resin is waterborne.

5. The tannin-blocking coating of claim 1, wherein the binder resin is a resin having silicon-based groups contained therein.

6. The tannin-blocking coating of claim 1, wherein the binder resin includes an alkali-soluble resin.

7. The tannin-blocking coating of claim 1, wherein the binder resin is acidic.

8. The tannin-blocking coating of claim 1, wherein the binder resin is cationic.

9. The tannin-blocking coating of claim 1, wherein the binder resin is a member selected from the group consisting of poly (meth) acrylics, epoxies, polyesters, polyvinyl esters, alkyds, polyurethanes, polyisocyanates, amino resins, latexes, and silicon-based resins.

10. A coatings system comprising:
a substrate;
a first coating layer arranged over the substrate; and
a second coating layer arranged over the first coating layer,
wherein the first coating layer comprises:
a binder resin; and
casein proteins, and
wherein the first coating layer mitigates tannin migration from the substrate to the second coating layer.

11. The coatings system of claim 10, wherein the substrate comprises tannins, wherein the first coating layer further comprises tannins, and wherein the second coating layer is substantially free of tannins.

12. The coatings system of claim 10, wherein the substrate comprises (i) wood, a wood composite, an engineered wood, or a combination thereof; or (ii) metal, plastic, ceramic, or a combination thereof.

13. The coatings system of claim 10, wherein the first coating layer is waterborne.

14. The coatings system of claim 10, wherein the binder resin comprises an alkali-soluble resin.

15. The coatings system of claim 10, wherein the binder resin is a resin having silicon-based groups contained therein.

16. The coatings system of claim 10, wherein the binder resin is cationic.

17. The coatings system of claim 10, wherein the binder resin is a member selected from the group consisting of poly (meth) acrylics, epoxies, polyesters, polyvinyl esters, alkyds, polyurethanes, polyisocyanates, amino resins, latexes, and silicon-based resins.

18. A method of coating a substrate comprising:
applying a first coating layer to the substrate; and
applying a second coating layer to the first coating layer,
wherein the first coating layer comprises:
a binder resin; and
casein proteins, and
wherein the first coating layer mitigates tannin migration from the substrate to the second coating layer.

19. The method of claim 18, wherein the substrate comprises: (i) wood, a wood composite, an engineered wood, or a combination thereof; or (ii) metal, plastic, ceramic, or a combination thereof.

20. The method of claim 18, wherein the first coating layer is water-based.

21. The method of claim 18, wherein before the first coating layer is applied to the substrate, the first coating layer has a first amount of brown color; and wherein after the first coating layer is applied to the substrate, the first coating layer has a second amount of brown color which is greater than the first amount.
